(19) United States
(12) Patent Application Publication
(10) Pub. No.: US 2026/0156221 A1
(43) Pub. Date: Jun. 4, 2026

(54) IMAGE FORMING APPARATUS

(71) Applicant: CANON KABUSHIKI KAISHA, Tokyo (JP)

(72) Inventor: SHINYA YASUDA, Ibaraki (JP)

(21) Appl. No.: 19/394,591

(22) Filed: Nov. 19, 2025

(30) Foreign Application Priority Data
Dec. 3, 2024 (JP) 2024-210642

(51) Int. Cl. H04N 1/00

(52) U.S. Cl. CPC H04N 1/00824; H04N 1/00559

(57) ABSTRACT

An image forming apparatus configured to form an image on a sheet includes an operation unit configured to receive an operation by a user and rotate around a rotation axis, the operation unit including a display unit configured to display the image, a reading unit configured to read the image formed on the sheet, and a support unit configured to support at least a portion of the operation unit and at least a portion of the reading unit.

### BACKGROUND

### Field of the Technology

The present disclosure relates to an image forming apparatus including a rotatable operation unit.

### Description of the Related Art

In recent years, there have been known image forming apparatuses in which an operation unit is made rotatable relative to the main body, with the aim of allowing users of various heights to view and operate the operation unit appropriately. U.S. Patent Publication No. 20130283944 A1 describes a configuration in which an operation unit that is rotatable about a rotation axis is attached to the main body.

When a user holds and rotates the operation unit as described in U.S. Patent Publication No. 20130283944 A1, a large load may be applied to an attachment portion of the operation unit to the main body. In this case, if the attachment portion is not strong enough to withstand the load applied by the user rotating the operation unit, the attachment portion may bend, thereby reducing the operability for the user.

### SUMMARY

The present disclosure is directed to providing an attachment configuration for a rotary operation unit to an image forming apparatus.

According to some embodiments of the present disclosure, an image forming apparatus configured to form an image on a sheet includes an operation unit configured to receive an operation by a user and rotate around a rotation axis, the operation unit including a display unit configured to display the image, a reading unit configured to read the image formed on the sheet, and a support unit configured to support at least a portion of the operation unit and at least a portion of the reading unit.

Features of the present disclosure will become apparent from the following description of embodiments with reference to the attached drawings. The following description of embodiments is described by way of example.

### BRIEF DESCRIPTION OF THE DRAWINGS

FIG. 1 is a front view of an image forming apparatus according to an embodiment.

FIG. 2 is a perspective view of the image forming apparatus according to the embodiment.

FIG. 3 is a perspective view of the image forming apparatus according to the embodiment.

FIG. 4 is a perspective view of the image forming apparatus according to the embodiment.

FIG. 5 is a cross-sectional view of an operation unit support member in the embodiment.

FIG. 6 is a perspective view of the operation unit support member in the embodiment.

FIG. 7 is a top view of the image forming apparatus according to the embodiment.

FIG. 8 is a perspective view of an operation unit in the embodiment.

### DESCRIPTION OF THE EMBODIMENT

Hereinafter, various exemplary embodiments, features and aspects of the present disclosure will be described by way of example with reference to the drawings. However, the dimensions, materials, shapes, and relative positions of the components in the embodiments described below may be changed as appropriate depending on a configuration and various conditions of the apparatus to which the present disclosure is applied, and are not intended to limit the scope of the present disclosure to only these examples.

### Overall Configuration of Image Forming Apparatus

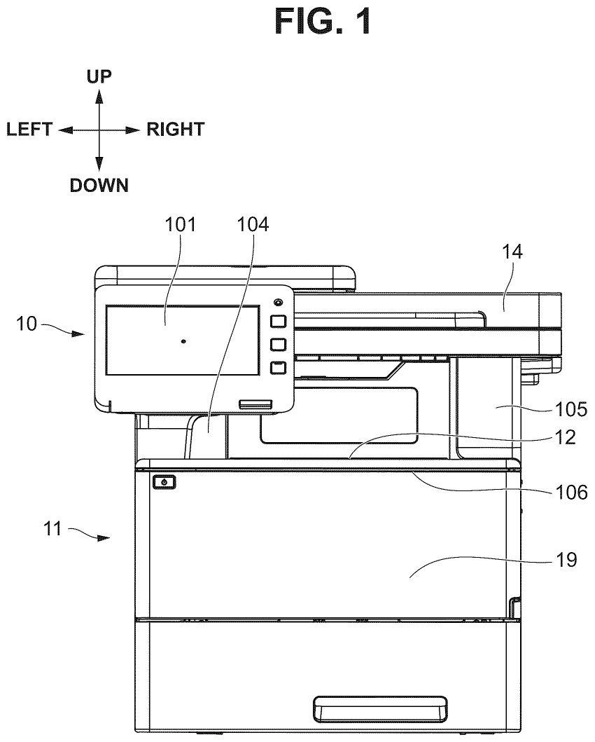

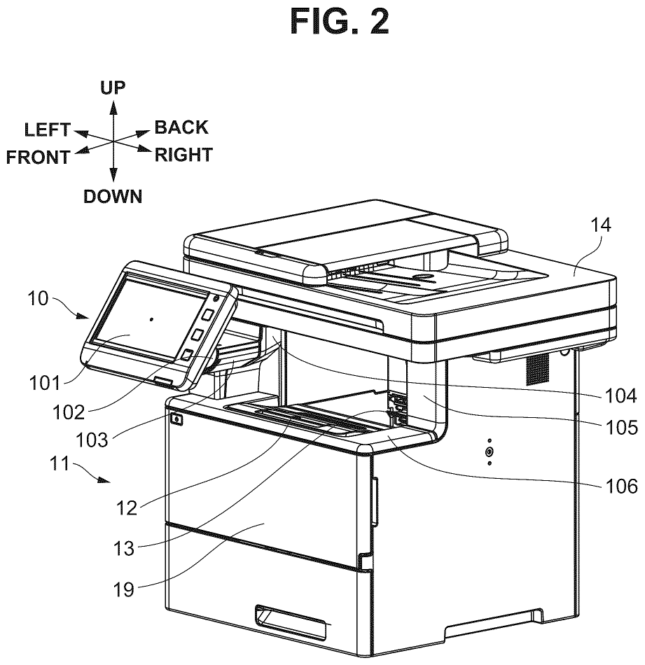

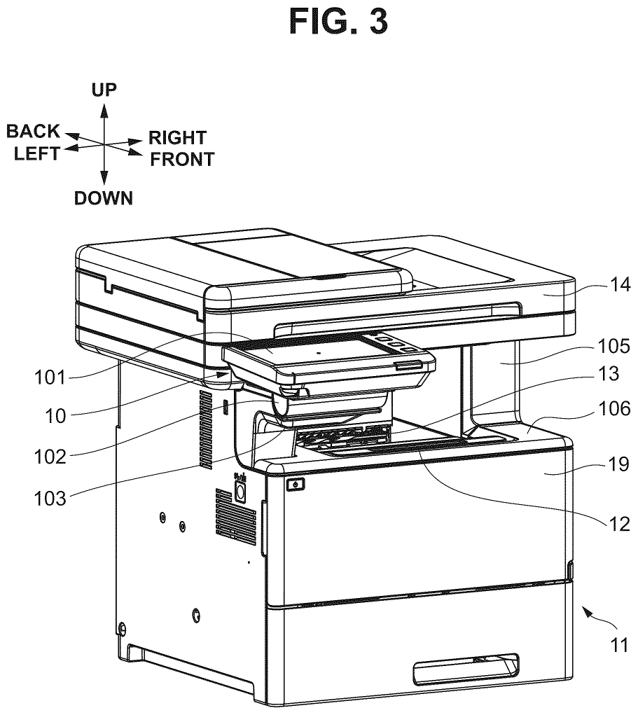

An overall configuration of an image forming apparatus in an embodiment will be described with reference to FIGS. 1 to 8. FIG. 1 is a front view of an image forming apparatus 11 in the present embodiment. As illustrated in FIG. 1, in the present embodiment, when facing the image forming apparatus 11, the direction of the left and right sides will be defined as the left-right direction, the direction of front and back sides will be defined as the front-back direction, and the direction corresponding to the vertical direction will be defined as the up-down direction. FIGS. 2 and 3 are perspective views of the image forming apparatus 11 in the present embodiment.

In the image forming apparatus 11 of the present embodiment, an image is recorded on a recording material such as a sheet by an image forming unit (not illustrated). A paper ejection unit 13 has a function of ejecting the recording material on which an image has been formed by the image forming unit out of the image forming apparatus 11. In the present embodiment, the recording material on which an image has been formed by the image forming unit is ejected from the back to the front of the image forming apparatus 11. The recording material ejected by the paper ejection unit 13 is stacked on a paper ejection tray 12.

A reading unit 14 has a function of reading out an image formed on a recording material and converting the same into image data. As illustrated in FIG. 2, in the present embodiment, the reading unit 14 is provided vertically above the paper ejection tray 12. The image read and converted into image data by the reading unit 14 is transferred to the image forming unit, where the image can be formed again on a recording material.

An operation unit 10 can accept operations related to image formation by a user and operate the image forming apparatus 11. The operation unit 10 includes a display unit 101 that displays information related to image formation, and the operation unit 10 is attached to the main body of the image forming apparatus via a hinge 102. The operation unit 10 can rotate around a rotation axis of the hinge 102, making it possible to change an angle of the display unit 101 relative to the user. When the user operates the image forming apparatus 11, an optimal angle at which the display unit 101 can be viewed varies depending on the body height of the user. In particular, users with a relatively low line of sight, such as those using wheelchairs, may find it difficult to view the display unit 101.

Rotating the operation unit 10 around the rotation axis allows the user to view the display unit 101 at an appropriate angle.

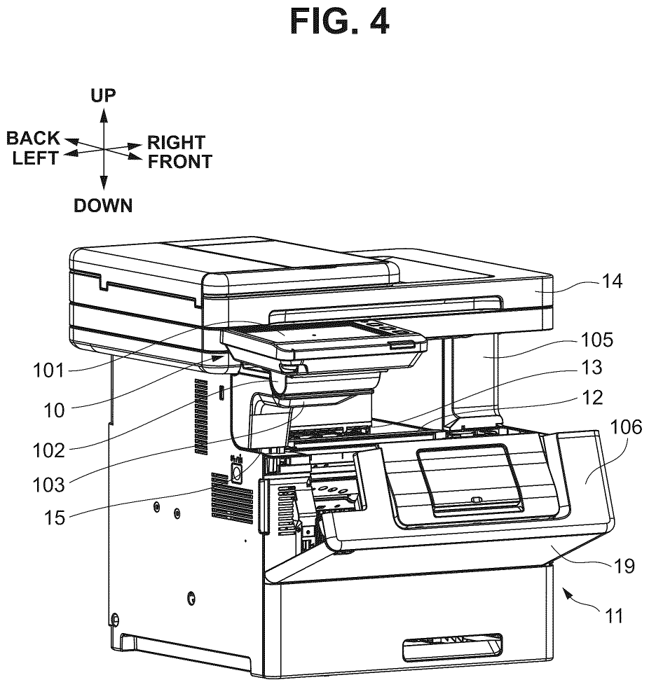

FIG. 4 is a diagram illustrating the image forming apparatus 11 of the present embodiment in which an opening/closing cover unit 19 is opened. The opening/closing cover unit 19 is opened or closed by rotating about a rotation axis extending in the left-right direction. When the opening/closing cover unit 19 is opened, it is possible to access the inside of the image forming apparatus 11.

The opening/closing cover unit 19 has an opening/closing cover 106 that forms the exterior of the image forming apparatus 11. The opening/closing cover 106 is provided across the front of the image forming apparatus 11 and the paper ejection unit 13.

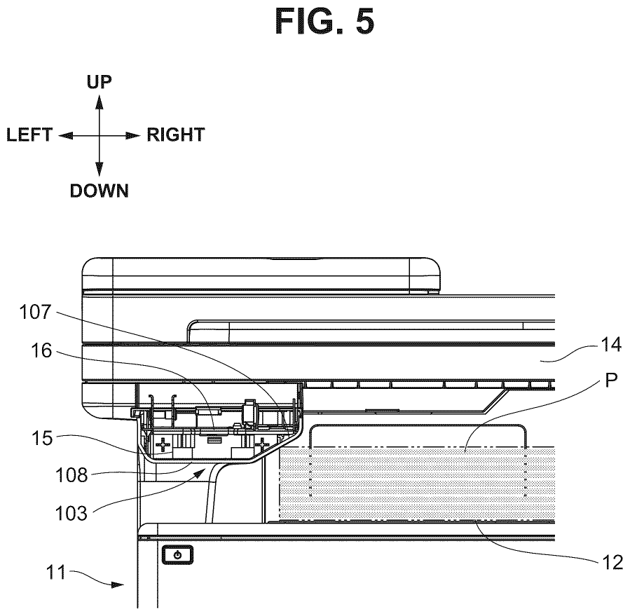

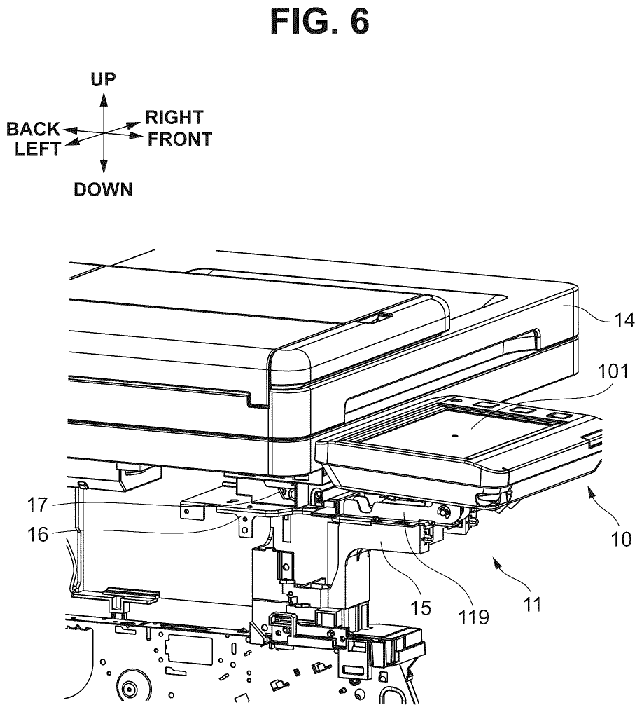

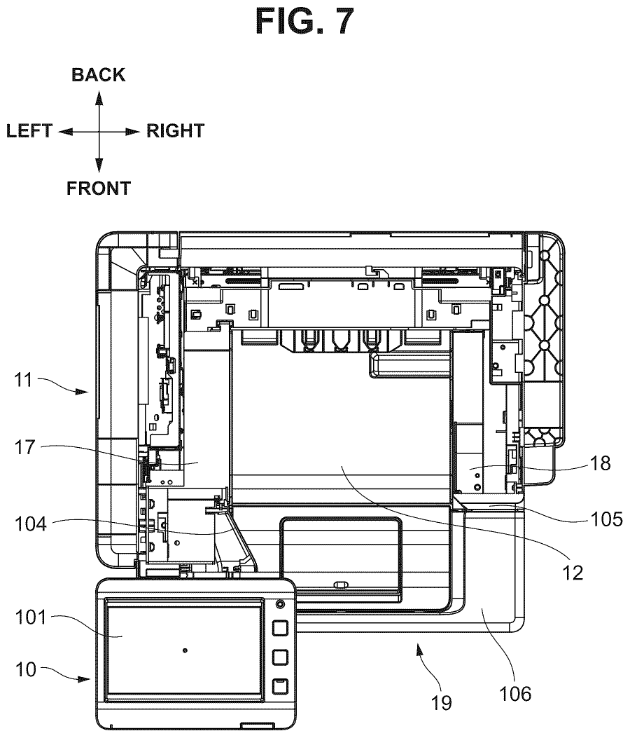

Next, a method for fixing the operation unit 10 and the reading unit 14 to the apparatus main body will be described in detail with reference to FIGS. 5 to 7. FIG. 5 is a cross-sectional view of an operation unit support member 15 when the image forming apparatus 11 is viewed from the front. FIG. 6 is a perspective view of a detailed configuration around the operation unit 10. FIG. 7 is a top view of the image forming apparatus 11 when seen from above in the vertical direction.

As illustrated in FIG. 5, at least a portion of the display unit 101 and at least a portion of an operation unit support member cover 103 are positioned so as to overlap the ejection tray 12 in the left-right direction. The distance between the paper stacking surface of the ejection tray 12 and the lower end of the operation unit support member cover 103 in the up-down direction will be defined as “maximum paper stacking height H”. Paper ejected onto the paper stacking surface may be curled. Accordingly, the maximum paper stacking height H is the sum of paper height and maximum ejection curl height when the maximum number of sheets are stacked on the ejection tray 12. The maximum ejection curl height is the maximum height of curl that occurs on paper in the up-down direction when the paper is ejected onto the ejection tray 12, which varies depending on conditions such as paper type, temperature, and humidity. For this reason, paper conveyance settings and image formation settings may be optimized for each product to satisfy curl height specifications for each product.

The maximum size of paper that can be stacked on the paper stacking surface of the ejection tray 12 will be defined as “maximum paper stacking width W”. The area (ejection space) surrounded by the maximum paper stacking height H and the maximum paper stacking width W will be defined as maximum paper stacking area A. Conventionally, the operation unit 10 is arranged above the image forming apparatus 11 so as not to interfere with the trajectory of paper being ejected onto the paper stacking surface, making it difficult to reduce the size of the entire image forming apparatus. In the present embodiment, it is possible to achieve the size reduction of the entire image forming apparatus without interfering with the ejection of paper onto the paper stacking surface.

The reading unit 14 is supported above the main body of the image forming apparatus 11 by a first frame 17 and a second frame 18. The first frame 17 and the second frame 18 are positioned differently in the left-right direction. When facing the image forming apparatus 11, the first frame 17 supports the reading unit 14 on the left side of the paper ejection unit 13, and the second frame 18 supports the reading unit 14 on the right side of the paper ejection unit 13.

As illustrated in FIG. 7, the operation unit 10 is supported by an operation unit support plate 16 in addition to the operation unit support member 15.

Here, the operation unit support member 15 is a member that has a function of supporting the operation unit 10 and the reading unit 14 relative to the main body of the image forming apparatus 11. That is, the operation unit support member 15 corresponds to a first support member. As illustrated in FIG. 6, the operation unit support member 15 supports the operation unit 10 and the first frame 17, which supports the reading unit 14 via the operation unit support plate 16. That is, the operation unit support plate 16 corresponds to a second support member. In the vertical direction, the operation unit support plate 16 is provided between the first frame 17 and the operation unit support member 15. Furthermore, when viewed in the vertical direction, the first frame 17, the operation unit support plate 16, and the operation unit support member 15 overlap one another. In the present embodiment, the first frame 17 and the operation unit support member 15 are connected via the operation unit support plate 16 using screws (not illustrated), but other methods may be used for connection. That is, other methods such as welding or adhesive may also be used for connection.

In the front-back direction, the operation unit 10 is connected to the operation unit support member 15 at a position different from the position at which the first frame 17 is provided. The operation unit 10 has a hinge support plate 119 that supports the hinge 102. The hinge support plate 119 is connected to the operation unit support member 15 via the operation unit support plate 16. In other words, the operation unit support plate 16 is positioned between the hinge support plate 119 and the operation unit support member 15 in the vertical direction. When viewed in the vertical direction, the hinge support plate 119, the operation unit support plate 16, and the operation unit support member 15 overlap one another.

As described above, in the present embodiment, both the first frame 17 and the hinge support plate 119, which are provided at different positions in the front-back direction, are connected to the operation unit support member 15 via the operation unit support plate 16. When a user applies a load to rotate the operation unit 10, rotational moment is applied to the operation unit support member 15 and the operation unit support plate 16. At this time, the first frame 17 positioned at the back side of the operation unit support member 15 and the hinge support plate 119 positioned at the front side are connected via the common operation unit support plate 16, so that it is possible to reduce deformation of the operation unit support member 15 due to the rotational moment. Accordingly, when the user rotates the operation unit 10, it is possible to reduce the possibility that the user will recognize deformation, such as bending, of the members around the operation unit 10 incident to the rotational movement, thereby improving usability.

In the present embodiment, the operation unit support member 15 and the operation unit support plate 16 are made of metal such as aluminum or steel. When a user rotates the operation unit 10, a large load may be applied to the operation unit support member 15 and the operation unit support plate 16. Even in such a case, in order to reduce the risk of deformation of the members that support the operation unit 10, it is desirable that the operation unit support member 15 and the operation unit support plate 16 be made of a highly rigid material such as metal.

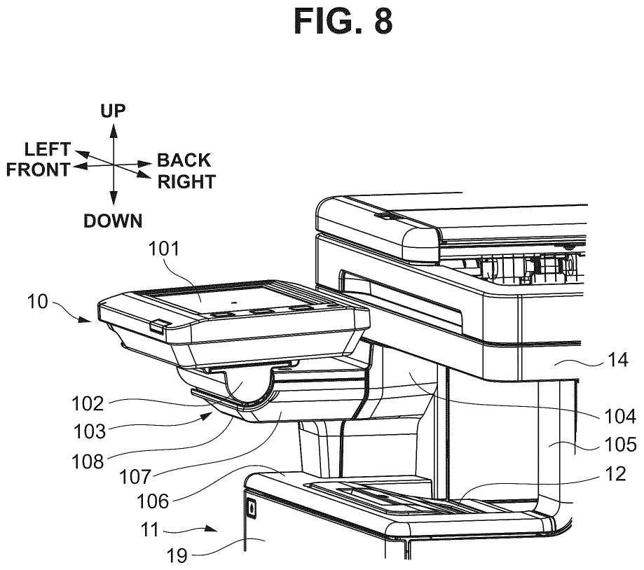

FIG. 8 is a perspective view of the periphery of the operation unit 10. As illustrated in FIG. 8, the operation unit support member 15 is covered by the operation unit support member cover 103 that forms the exterior of the image forming apparatus 11. The operation unit support member cover 103 is sloped such that its width in the left-right direction narrows as it goes vertically downward. This increases the area that is accessible to the paper ejection unit 13, allowing the user to easily access the recording material ejected to the paper ejection unit 13.

As described above, in the present embodiment, the operation unit 10 and the reading unit 14 are supported by the operation unit support member 15 via the operation unit support plate 16. In the vertical direction, the operation unit support plate 16 is positioned between at least a portion of the operation unit 10 and the operation unit support member 15 and between at least a portion of the reading unit 14 and the operation unit support member 15. When viewed in the vertical direction, the operation unit 10, at least a portion of the operation unit support plate 16, and at least a portion of the operation unit support member 15 overlap one another. Furthermore, at least a portion of the reading unit 14, at least a portion of the operation unit support plate 16, and at least a portion of the operation unit support member 15 overlap one another. Attaching the operation unit 10 in the above-described arrangement makes it possible to reduce the risk of the operation unit support member 15 bending and deforming even when a load is applied to rotate the operation unit 10.

According to the present disclosure, it is possible to provide an attachment configuration for a rotary operation unit to an image forming apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-210642, filed Dec. 3, 2024, which is hereby incorporated by reference herein in its entirety.

What is claimed is:

1. An image forming apparatus configured to form an image on a sheet, comprising:
an operation unit configured to receive an operation by a user and rotate around a rotation axis, the operation unit including a display unit configured to display the image;
a reading unit configured to read the image formed on the sheet; and
a support unit configured to support at least a portion of the operation unit and at least a portion of the reading unit.

2. The image forming apparatus according to claim 1, wherein at least a portion of the operation unit is supported by the support unit in front of the reading unit in a front-back direction when facing the image forming apparatus.

3. The image forming apparatus according to claim 2,
wherein the support unit is a first support unit,
wherein the first support unit supports at least a portion of the reading unit and at least a portion of the operation unit, the reading unit being positioned above the first support unit in a vertical direction, and
wherein a second support unit is provided between the first support unit and at least a portion of the reading unit and between the first support unit and at least a portion of the operation unit in the vertical direction.

4. The image forming apparatus according to claim 3, wherein when viewed in the vertical direction, at least a portion of the first support unit, at least a portion of the second support unit, and at least a portion of the reading unit overlap one another.

5. The image forming apparatus according to claim 4, wherein when viewed in the vertical direction, at least a portion of the first support unit, at least a portion of the second support unit, and at least a portion of the operation unit overlap one another.

6. The image forming apparatus according to claim 1, wherein
the operation unit is attached to the image forming apparatus via a hinge, and the rotation axis is a rotation axis of the hinge.
